(19) United States
(12) Patent Application Publication
(10) Pub. No.: US 2009/0072077 A1
(43) Pub. Date: Mar. 19, 2009

(54) High passenger capacity airplane

(76) Inventor: Chui Wen Chiu, Toronto (CA)

Correspondence Address: CHIU Chui Wen, 9 NORDIC PLACE, TORONTO, ON, M3A 2H8, CA

(21) Appl. No.: 11/898,940

(22) Filed: Sep. 18, 2007

(51) Int. Cl. B64C 1/00; B64D 11/00

(52) U.S. Cl. 244/15

(57) ABSTRACT

A high capacity passenger airplane is provided with a plurality of fuselages releasably mounted on it wings section. Each fuselage has an outer shell with a plurality of passenger cabins mounted in tandem with the shell. The passenger cabins are equipped with sliding wheels such that they may be discharged through a rear exit door of the fuselage to separate from the airplane in accident. Each passenger cabin is equipped with safety parachutes and external safety air bags at its underside such that it may be safely landed on ground or on water after having discharged from a fuselage.

### BACKGROUND OF THE INVENTION

1. Field of the Invention

This invention relates to airplane construction and more specifically to a passenger airplane having a large passenger capacity.

2. Background Art

As air traveling becomes ever more common and popular, commercial airlines must increase the number of flights to various destinations in order to meet the demand. However, the increase of the number of air flights would invariably create air traffic congestion. In order to alleviate the air traffic congestion problem as well as meet the high demand of carrying as many passenger as possible, commercial airlines have been demanding larger airplanes which are capable of carrying a large number of passengers. Airplane manufacturers such as Boeing and Air Bus construct large body airplanes such as the 737, 747, 787, and A380 for carrying a large number of passengers yet these large commercial airplanes are still lacking the capability to carry 1000 to 5000 passengers.

### BACKGROUND OF THE INVENTION

It is a principal object of the present invention to provide an advanced airplane construction having a passenger capacity of over 2000 passengers so as to meet the high demand of air travel.

It is another object of the present invention to provide a jumbo airplane construction having a safety provision that allows the passengers to escape fatality in the event of an accident.

It is another object of the present invention to provide a passenger airplane construction having a plurality of separate passenger carrying sections.

It is yet another object of the present invention to provide a large passenger capacity airplane having safety provisions for saving the lives of the passengers in the event of an air accident.

### BRIEF DESCRIPTION OF THE DRAWINGS

The invention will now be described with reference to the accompanying drawings in which:

FIG. 1 is a perspective top and side elevation view of the airplane according to the present invention.

FIG. 2 is a perspective front elevation view of the airplane.

FIG. 3 is a perspective bottom elevation view of the airplane.

FIG. 4 is a partial sectional front view of the airplane along the section line A-A of FIG. 1.

FIG. 5 is a perspective top and side elevation view of the airplane showing the provision of separable passenger cabins located within its fuselage.

FIG. 6 is an isolated side elevation view showing the provision of a ramp deployable at the rear of the airplane to allow a passenger cabin to be separated from the fuselage in the event of an accident.

FIG. 7 is a perspective top elevation view showing the mounting of the plurality of fuselages to the wing section of the airplane.

FIG. 8 is an isolated perspective top elevation view showing the linkage between the fuselages to allow emergency personnel to move between the fuselages.

FIG. 9 is an isolated sectional view showing the mounting of the fuselages to the wing section of the airplane.

### DETAILED DESCRIPTION OF THE PREFERRED EMBODIMENTS

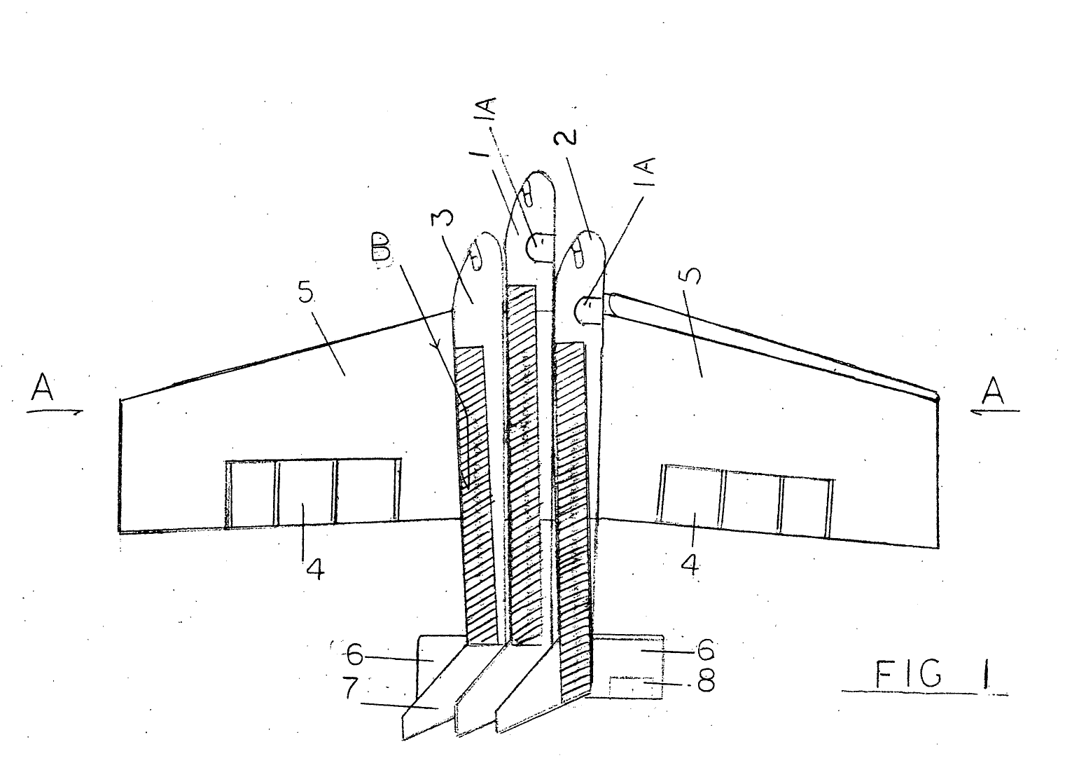

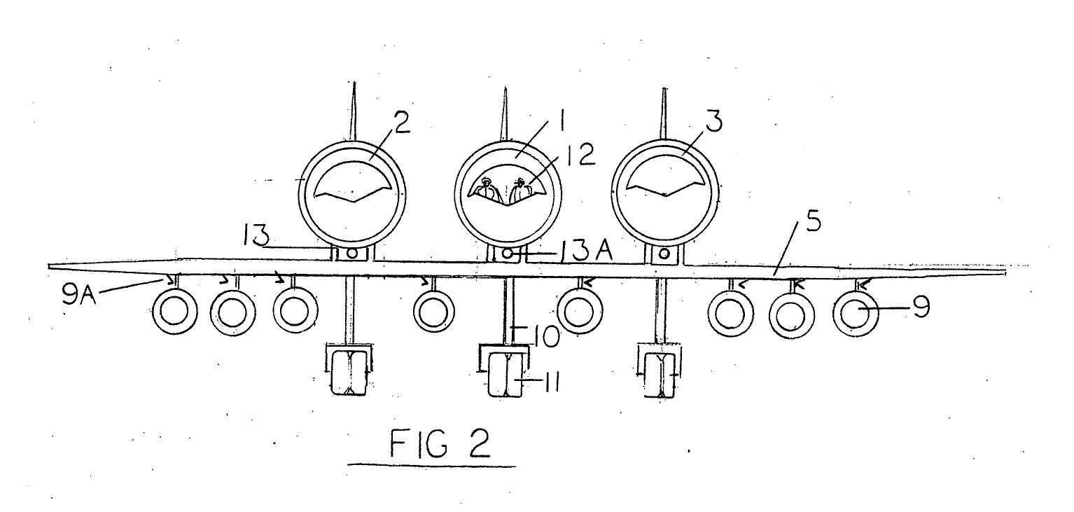

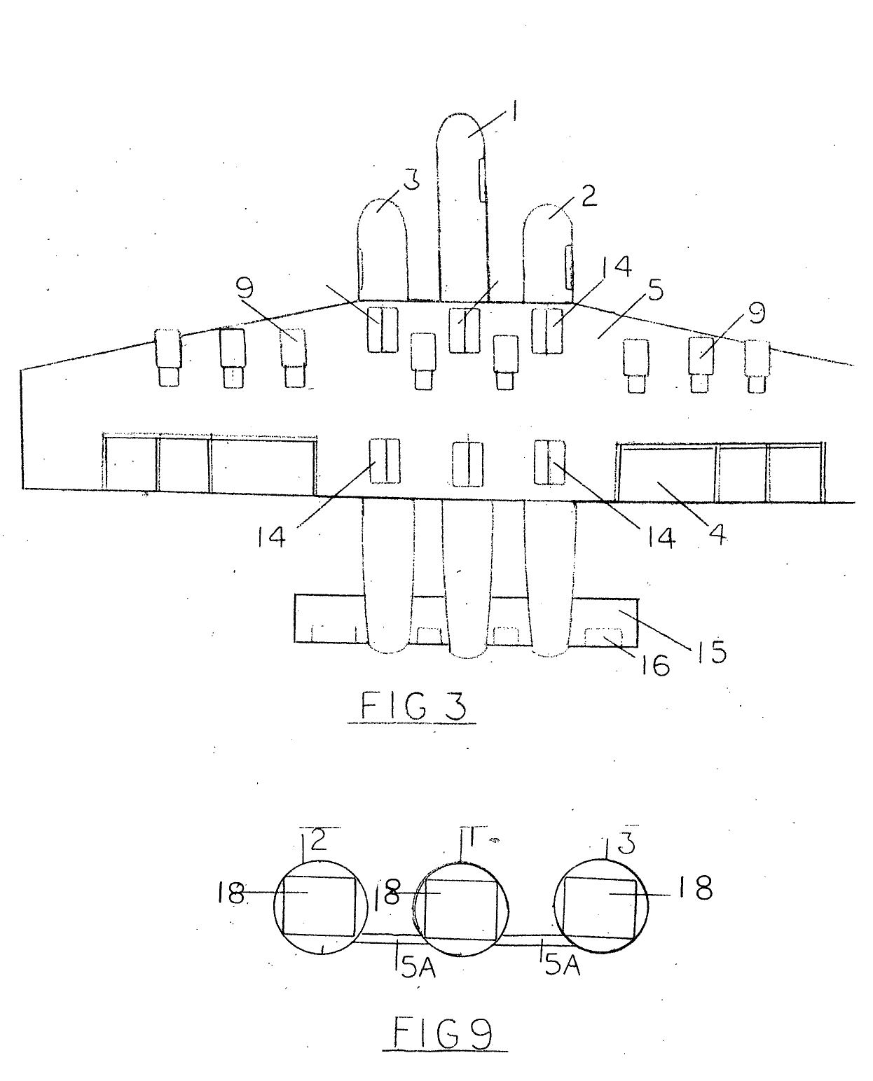

According to the present invention, a plurality of fuselages are provided on an airplane in order to increase its passenger capacity. Three fuselages 1, 2 and 3 in the form of a hollow shell are shown as an exemplary embodiment, it can be understood by those skilled in the art that two or more than three fuselages may be provided according to the present invention for the same purposes. As shown in FIG. 1, three fuselages 1, 2 and 3 are provided for the airplane and are mounted to the wings section 5 and the fuselages are coupled to one another with a linkage 5A. Each fuselage has an entrance door 1A and an emergency exit door 1B. The wings 5 have airfoil flaps 4 located at the trailing edge of the wings 5. The rear end of the fuselages 1, 2 and 3 are mounted on the tail airfoil 6 which has pivotable control flaps 8. A rudder 7 is provided at the rear end of each of the fuselages 1, 2 and 3. The jet engines 9 are located at the underside of the wings 5 as best shown in FIG. 3, and they are mounted to the wings 5 with severable mounting 9A. The landing wheels 11 are mounted to the pivotable support 10. The main control cabin 12 is located at the front end of the center fuselage 1. However, each fuselage is provided with a control cabin such that, in case emergency, the control cabin of any fuselage may be employed to control the airplane. Each fuselage is mounted to the wings section 5 with a severable mounting 13 which is operative with pneumatic control 13A. The pneumatic control 13A can be operated in the event of an accident for separating the fuselage from the wings section 5. The landing wheels 11 can be located in a retracted position 14 under the wings section 5 as shown in FIG. 3. The tail airfoil may be in the form of an elongated airfoil 15 having a plurality of control flaps 16 as shown in FIG. 3.

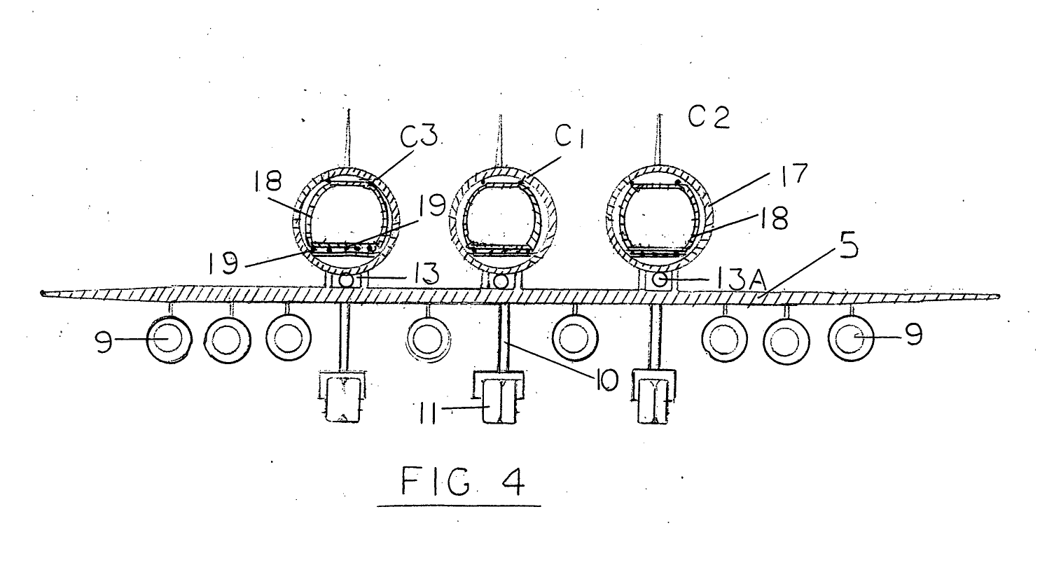

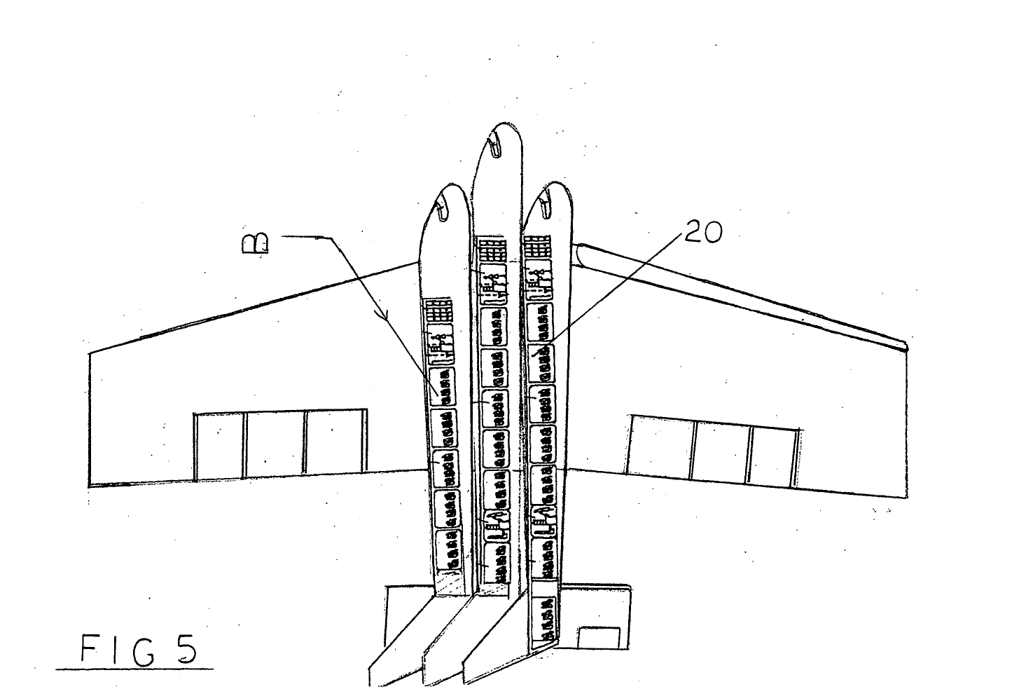

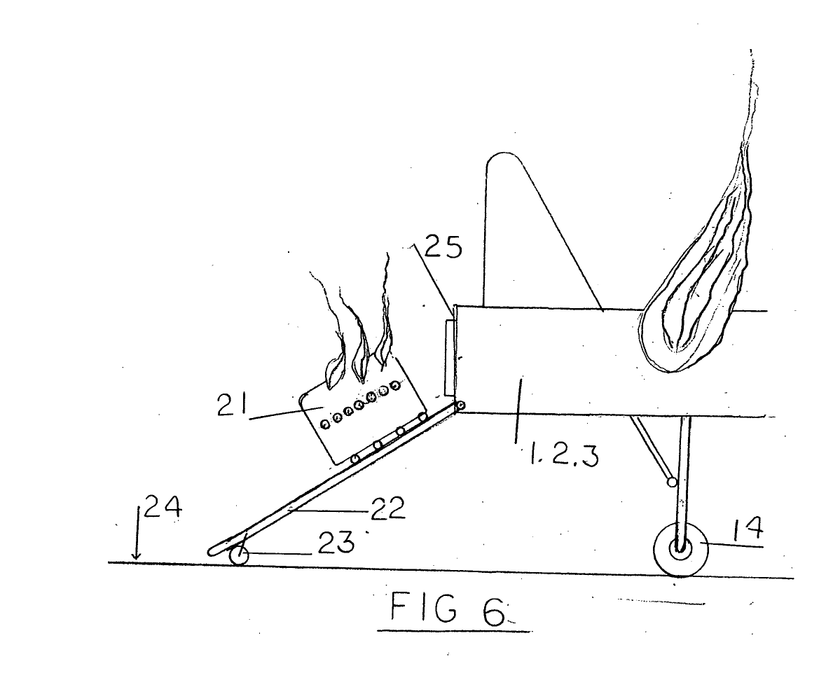

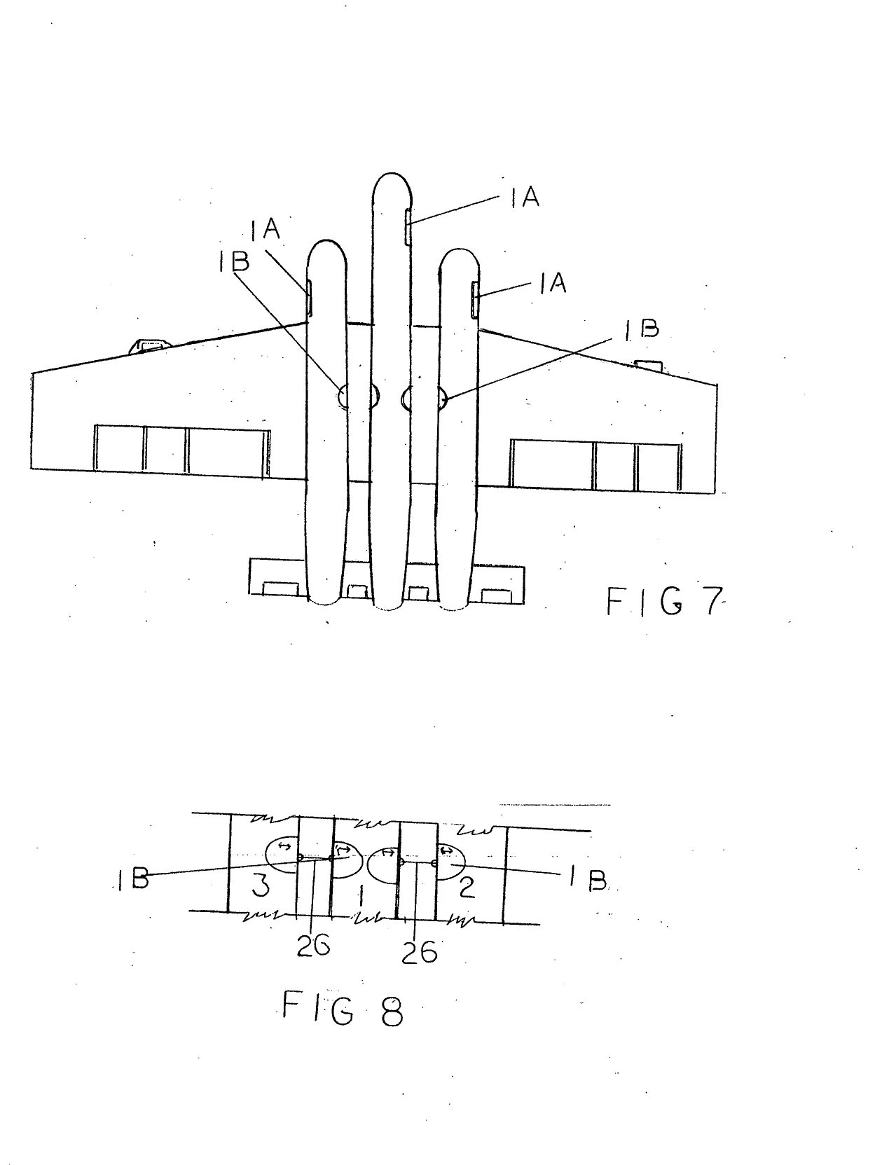

As shown in FIGS. 4 and 5, each fuselage has an outer shell 17, and a plurality of passenger cabins 20 shown in cross section 18 are located in a tandem manner within the fuselage with rotatable wheels 19 so that in the event of an emergency the passenger cabins 20 may be slidably separated and discharged from the fuselage serially through a rear exit door 25 of the latter.

In the event of fire while the airplane is on the runway 24, either during takeoff or landing, the individual passenger cabin 21 may be safely discharged serially from the burning fuselage through the rear exit door 25 with a slider gangway 22 supported on the ground with support wheel 23.

The plurality of fuselages and passenger cabins facilitate a large number of more than 2000 passengers to be carried by the airplane of the present invention.

Each fuselage may be separated from the wings section 5 by operating the pneumatic mechanism 13A to sever the mounting 13 such that the fuselage in distress may be slidably separated from the wings section 5 either from the front or from the rear. Thus, any fuselage may be safely separated from the remainder of the plane which is in trouble or vice versa so that a fuselage in trouble may be safely separated from the remainder of the plane.

The individual passenger cabins 20 are provided with safety parachutes such that upon the separation of the fuselage from the wings section 5 in air, the passenger cabins 20 may be discharged from the fuselage to land safely back on the ground. Deployable safety air bags are also provided at the underside of each passenger cabin 20 to ensure a safe landing on the ground or to provide floatation to the cabin when it lands on water.

Any jet engines 9 which may cease operation for unknown reasons or be on fire, may also be individually shut down and/or removed from the wings section 5 in case of accident by operating the severable mounting 9A which would terminate the supply of the fuel to the engine as well as turning off the engine's ignition and extinguishing any engine fire prior to releasing it from the wings section 5.

Safety ropes 26 are provided between the emergency exit doors 1B of the fuselages such that in case of emergency the safety control personnel may move from one fuselage to the other.

Each passenger cabin is provided with access doors which can be completely sealed automatically prior to the cabin separating from the fuselage. The individual safely sealed passenger cabin provided with parachutes and safe landing air bags may thus safely be returned to the ground in case of an air accident for saving the passengers.

When landed on water, the safety air bags at the underside of the discharged passenger cabin would be deployed for supporting the cabin to float on water to await for rescue.

While preferred embodiments of the invention have been described above. It will be recognized and understood that various modifications may be made therein and the appended claims are intended to cover all such modifications which may fall within the spirit and scope of the invention.

What is claimed is:

1. A high passenger capacity airplane having a wings section, comprising,
a plurality of fuselages mounted on said wings sections, each fuselage including an outer hollow shell and a plurality of individual passenger cabins removably located in tandem within said shell for accommodating a large number of passengers,
each of said fuselages having a control cabin located at a front end for locating controls for said airplane and for each fuselage selectively,
a plurality of jet engines releasably mounted at an underside of said wings section with a severable mechanism.

2. A high passenger capacity airplane according to claim 1 wherein a discharge door is provided at the rear of each fuselage, and said discharge door is operative to allow said passenger cabins to be discharged from said each fuselage in an accident.

3. A high passenger capacity airplane according to claim 2 wherein each one of said passenger cabins is equipped with safety parachutes operative for landing a passenger cabin discharged from a fuselage.

4. A high passenger capacity airplane according to claim 3 wherein each one of said passenger cabins is equipped with safety air bags at an underside of said cabins and said air bags are operative for safely landing said passenger cabins on land and providing floatation to said cabins when landed on water.

5. A high passenger capacity airplane according to claim 4 said severable mechanism for mounting said jet engines to said wings section is operative to terminate fuel supply, extinguishing any burning fire, and to release a selected disabled engine.

6. A high passenger capacity airplane according to claim 5 wherein each of said passenger cabins is equipped with safety doors, said doors being automatically sealed prior to said passenger cabin being discharged from a fuselage.

7. A high passenger capacity airplane according to claim 6 wherein said fuselages are mounted to said wings section with severable mounting operative for releasing a selected fuselage from said wings section.

8. A high passenger capacity airplane according to claim 7 wherein said fuselages are individually releasable from said wings section selectively through a front end and a rear end.

9. A high passenger capacity airplane according to claim 8 including a slider gangway located at a rear exit door of each fuselage and being operative for discharging said passenger cabins from a respective fuselage on land.
